(19) United States
(12) Patent Application Publication
(10) Pub. No.: US 2026/0254973 A1
(43) Pub. Date: Aug. 27, 2026

(54) Deriving Video Frame Status From Rate Control Feedback

(71) Applicant: Telefonaktiebolaget LM Ericsson (publ), Stockholm (SE)

(72) Inventors: András Kern, Budapest (HU); Bence Formanek, Budapest (HU); Balázs Peter Gerö, Budapest (HU); Dávid Jocha, Budapest (HU)

(21) Appl. No.: 19/163,194

(22) PCT Filed: Mar. 9, 2023
(86) PCT No.: PCT/EP2023/056002

§ 371 Date: Sep. 8, 2025

(51) Int. Cl. H04N 19/172; H04N 19/105; H04N 19/159; H04N 19/164; H04N 19/174

(52) U.S. Cl. CPC H04N 19/172; H04N 19/105; H04N 19/159; H04N 19/164; H04N 19/174

(57) ABSTRACT

An encoding system (110) receives a report from a decoding system (120). The report identifies a packet comprising a first video portion of a video stream and comprises feedback indicating whether the first video portion was successfully received by the decoding system (120). The encoding system (110) configures a video encoder (115) to encode a second video portion of the video stream based on whether the feedback indicates that the first video portion was successfully received. Correspondingly, the decoding system (120) sends the report and decodes the second video portion in accordance with the encoding.

### TECHNICAL FIELD

The present disclosure generally relates to video streaming within a network and more particularly relates to techniques for enhancing video encoding.

### BACKGROUND

There are types of cloud-based applications, such as gaming or Augmented Reality (AR), that benefit from generating the frames to be shown to the end user at a remote server (e.g., at a datacenter) rather than on the end device. Such an application may stream these frames from the server to the edge device. To decrease the required network resources for such streaming, video encoding techniques have been applied, such as H.264 and H.265 (also known as High Efficiency Video Coding (HEVC)). Besides reducing network resources, these applications traditionally set stringent end-to-end latency requirements that necessitate configuring the encoder to minimize the time needed to encode and transmit the video stream.

### SUMMARY

The present disclosure is generally directed to an encoding system that keeps track of the reception status of transmitted packets and determines whether the frame carried by the packets is available at the decoding system. The encoding system configures a video encoder based on this information. A decoding system corresponding provides the reception status of packets transmitted by the encoding system and decodes in accordance with the video encoder.

Embodiments of the present disclosure include a method implemented by an encoding system. The method comprises receiving a report from a decoding system. The report identifies a packet comprising a first video portion of a video stream. The report comprises feedback indicating whether the first video portion was successfully received by the decoding system. The method further comprises configuring a video encoder to encode a second video portion of the video stream based on whether the feedback indicates that the first video portion was successfully received.

In some embodiments, configuring the video encoder based on the feedback comprises configuring the video encoder to encode the second video portion without reference to the first video portion in response to the feedback indicating that the first video portion was not successfully received. In some such embodiments, configuring the video encoder to encode the second video portion without reference to the first video portion comprises configuring the video encoder to designate a video slice comprising the first video portion as intra-frame encoded. In other such embodiments, configuring the video encoder to encode the second video portion without reference to the first video portion comprises configuring the video encoder to encode the second video portion as an Instantaneous Decoding Refresh (IDR) frame. In some embodiments, configuring the video encoder to encode the second video portion as an IDR frame is responsive to the feedback and at least one further feedback received from the decoding system together indicating that an entirety of a video frame comprising the first video portion was not successfully received.

In some embodiments, configuring the video encoder based on the feedback comprises configuring the video encoder to encode the second video portion using a video frame comprising the first video portion as a reference frame in response to the feedback indicating that the first video portion was successfully received. In some such embodiments, configuring the video encoder to encode the second video portion using the video frame as the reference frame is in further response to the feedback and at least one further feedback received from the decoding system together indicating that an entirety of the video frame was successfully received at the decoding system.

In some embodiments, the feedback indicates that the first video portion was successfully received by indicating that a video slice comprising the first video portion was successfully received at the decoding system.

In some embodiments, the method further comprises storing, in a datastore for each of a plurality of packets carrying respective portions of the video stream, an entry that associates a packet identifier that identifies the packet and a frame identifier that identifies a video frame comprising the respective portion with decoder feedback indicating whether respective portion is decodable by the decoding system. In some such embodiments, the method further comprises adding a further entry to the datastore for the packet based on the report.

In some embodiments, the method further comprises determining a one-way network delay between a transmission time of the packet from the encoding system and a reception time of the packet at the decoding system. The method further comprises interpreting the feedback as indicating that the first video portion is either decodable or not decodable based respectively on whether or not the one-way network delay is less than a threshold.

Other embodiments include an encoding system comprising interface circuitry and processing circuitry communicatively connected to the interface circuitry. The processing circuitry is configured to receive a report from a decoding system via the interface circuitry. The report identifies a packet comprising a first video portion of a video stream. The report comprises feedback indicating whether the first video portion was successfully received by the decoding system. The processing circuitry is further configured to configure a video encoder to encode a second video portion of the video stream based on whether the feedback indicates that the first video portion was successfully received.

In some embodiments, the processing circuitry is further configured to perform any of the methods described above.

Other embodiments include a computer program comprising instructions that, when executed on processing circuitry of an encoding system, causes the encoding system to carry out any of the methods described above.

Yet other embodiments include a carrier containing the aforementioned computer program. The carrier is one of an electronic signal, optical signal, radio signal, or computer readable storage medium.

Embodiments of the present disclosure also include a method implemented by a decoding system. The method comprises transmitting a report to an encoding system. The report identifies a packet comprising a first video portion of a video stream. The report comprises feedback indicating whether the first video portion was successfully received by the decoding system. The method further comprises receiving, from the encoding system, a further packet comprising a second video portion of the video stream encoded either with or without reference to the first video portion based respectively on whether or not the feedback indicated that the first video portion was successfully received. The method further comprises decoding the second video portion according to how the second video portion is encoded.

In some embodiments, the second video portion is encoded as an Instantaneous Decoding Refresh (IDR) frame responsive to the feedback indicating that the first video portion was not successfully received. In some such embodiments, the second video portion is encoded as an IDR frame responsive to the feedback and at least one further feedback transmitted to the encoding system (110) together indicating that an entirety of a video frame comprising the first video portion was not successfully received.

In some embodiments, the second video portion is encoded using a video frame comprising the first video portion as a reference frame in response to the feedback indicating that the first video portion was successfully received. In some such embodiments, the second video portion is encoded using the video frame comprising the first video portion as the reference frame in response to the feedback and at least one further feedback transmitted to the encoding system together indicating that an entirety of the video frame was successfully received.

In some embodiments, the feedback indicates that the first video portion was successfully received by indicating that a video slice comprising the first video portion was successfully received at the decoding system.

Other embodiments include a decoding system comprising interface circuitry and processing circuitry communicatively connected to the interface circuitry. The processing circuitry is configured to transmit a report to an encoding system via the interface circuitry. The report identifies a packet comprising a first video portion of a video stream. The report comprises feedback indicating whether the first video portion was successfully received by the decoding system. The processing circuitry is further configured to receive, from the encoding system via the interface circuitry, a further packet comprising a second video portion of the video stream encoded either with or without reference to the first video portion based respectively on whether or not the feedback indicated that the first video portion was successfully received. The processing circuitry is further configured to decode the second video portion according to how the second video portion is encoded.

In some embodiments, the processing circuitry is further configured to perform any of the methods implemented by a decoding system described above.

Other embodiments include a computer program comprising instructions that, when executed on processing circuitry of a decoding system, causes the decoding system to carry out any of the methods implemented by a decoding system described above.

Still other embodiments include a carrier containing the aforementioned computer program. The carrier is one of an electronic signal, optical signal, radio signal, or computer readable storage medium.

### BRIEF DESCRIPTION OF THE FIGURES

Aspects of the present disclosure are illustrated by way of example and are not limited by the accompanying figures with like references indicating like elements.

FIGS. 1A and 1B are schematic block diagrams illustrating examples of networks in accordance with embodiments of the present disclosure.

FIG. 2 is a flow diagram illustrating an example method of encapsulating RTP packets, according to one or more embodiments of the present disclosure.

FIG. 3 is a flow diagram illustrating an example method of tracking packet reception status, according to one or more embodiments of the present disclosure.

FIG. 4 is a flow diagram illustrating an example method implemented by an encoding system, according to one or more embodiments of the present disclosure.

FIG. 5 is a flow diagram illustrating an example method implemented by a decoding system, according to one or more embodiments of the present disclosure.

FIG. 6 is a block diagram schematically illustrating an example encoding system, according to one or more embodiments of the present disclosure.

FIG. 7 is a block diagram schematically illustrating an example decoding system, according to one or more embodiments of the present disclosure.

### DETAILED DESCRIPTION

Traditional encoders may use information of previously coded frames to encode a current frame. A previously encoded frame used in this way is typically referred to as a reference picture and a frame that is encoded using a reference picture is typically referred to as a Predictive frame (P-frame). Frames that can start a decoding session do not refer to other pictures. Such frames are typically referred to as Instantaneous Decoding Refresh (IDR) frames.

Using predictions during encoding of a video frame results in significantly smaller output. A typical encoder configuration for cloud gaming or AR minimizes both encoding time and required capacity by encoding video streams as a series of predictive frames, each referring to the previous one after sending an IDR frame in the beginning. The downside is that if a frame cannot be correctly decoded, the errors impair all subsequent frames that refer to the failed one. Such error propagation traditionally results in visible artifacts on the image sequence for a long period of time. The stringent latency requirements on the remote rendering and streaming solution typically excludes packet loss handling techniques, e.g., resending missing packets.

The visible artifacts caused by packet loss may be overcome in a variety of ways. For example, the encoder may send IDR frames periodically, regardless of whether there was any transmission error between the IDR frames. This limits the amount that errors can propagate. Additionally or alternatively, the encoder may receive an explicit error indication from the decoder and, in response, encode the next frame as an IDR frame. This is often referred to as Forced IDR. Additionally or alternatively, the encoder may use only use frames that have been successfully decoded as reference frames. Reference frames that have successfully been decoded can also be kept by the system and used as a reference for an indefinite period of time, which makes them a reliable resource. Such reference frames are often referred to as long-term reference frames.

The data network, over which the encoded frames are transmitted, does not guarantee that all encoded frames are transmitted without error and on time. For example, a packet may be lost due to erroneous transmission between data network nodes. A packet may not arrive at the receiver in time or may even be lost when an intermediate node of the data network does not have enough capacity towards the downstream next node in order to forward the packet. In such case, the node may store the packet in an intermediate queue and, if that queue is full, may simply drop the packet.

Real-time Transport Protocol (RTP) has been developed to transmit, among other things, encoded video frames over an IP based network for different encoder classes. As the size of an encoded video frame can be larger than the maximum size of a single IP packet to be transferred over a network in one unit, a standardized RTP encapsulation function splits the content of an encoded frame and encapsulates the resulting fragments into IP packets together with additional headers defined by the RTP protocol designed for the encoder type (e.g., H.265). Along with the encoded video frame, the encoder provides metadata to the encapsulation procedure.

To control the data stream, an additional protocol, the Real-time Transport Control Protocol (RTCP) is defined. One RTCP session is created for each RTP session. Among other things, the receiver can provide decoding feedback to the transmitter with the help of RTCP feedback messages. For example, the Picture Loss Indication (PLI) RTCP message can be sent by the decoder to inform the encoder of a loss of encoded video data belonging to one or more pictures. As a subsequent action, the encoder may encode the next frame as IDR. The Reference Picture Selection Indication (RPSI) RTCP message enables the decoder to communicate identifiers of pictures or slices that were correctly decoded to the encoder. As a result, the encoder can adjust which frames are used as long-term reference frames.

The throughput of a data network available for the encoded video stream may vary, especially in wireless networks. The streamer typically detects these throughput changes and adapts the size of the video stream to avoid network congestion, which may result in increased network delay and packet loss. For this purpose, rate control algorithms are often utilized. Such algorithms may run on the transmission side (i.e., where the encoding happens). In some examples, the receiver side generates feedback regarding RTP packet loss, congestion, and/or timing to the transmitter running the rate control algorithm. In response, the rate control algorithm at the transmitter proposes a target bitrate for the encoded video stream that the encoder should obey. An example transmitter side rate control solution is Self-Clocked Rate Adaptation for Multimedia (SCReAM).

Although existing PLI and RPSI based indication techniques support suppressing video artifacts caused by the packet loss, these techniques as currently known in the art have drawbacks. For example, Forced IDR using PLI generates an IDR frame that is generally a few times larger than typical P-Frames. Thus, when packet loss or unacceptable delay is caused by network congestion, increasing the throughput can easily lead to additional delay and packet loss.

As another example, indicating successfully or unsuccessfully decoded frames to the encoder via RTCP adds latency to the frame encoding control loop. For example, when a frame cannot be decoded due to packet loss, some parts of the frame may go missing. The decoder detects this after processing the frame, which may have been stored in a jitter buffer. An RTCP message that encodes an indication of the picture loss is then generated, transmitted across the network, and processed by the transmitter. All these steps contribute to the delay of the reaction of the encoder. These delays accumulate and results in long, visible video artifacts or freezes if the failed frames are simply dropped.

Further still, these existing techniques generally require the encoder and the decoder to use a synchronized frame ID set and provide an API to use these frame IDs, e.g., during reference frame configuration.

In view of the above, example embodiments of the present disclosure may improve upon known techniques by having the encoding system estimate whether all pieces of a previously sent encoded frame are available at the decoding system based on per packet feedback from the decoding system. The feedback indicates successful arrival of video stream packets. The encoding system may then respond accordingly, e.g., by making a successfully received and decoded frame a reference for subsequent frames yet to be encoded. The encoding system can also declare a frame unsuccessful and generate an IDR frame in response.

At least some of the embodiments proposed herein speed up the frame decoding feedback loop at the expense of a small risk of false positive acknowledgements. By sending feedback immediately when all required RTP packets have arrived, a 10-40 ms improvement is generally expected depending on the decoding duration (which is typically less than 5 ms) and the jitter buffer configuration (which is typically in the range of 10-40 ms).

A faster frame decoding feedback loop has several advantages. For example, the encoder may react to errors earlier, thereby making video artifacts visible for a shorter period of time. Moreover, in conjunction with a reference frame positive acknowledgement technique, frames can be used as a reference for longer without risking quality, which in turn enables improved frame quality or smaller frame size through better compression.

Another advantage may be to decrease RTCP stream rate without compromising control loop latency. Decreasing the uplink data rates is important in a radio environment. For example, current RTCP RPSI messages are required to be sent immediately in a dedicated RTCP packet to minimize the latency of receiving the feedback. The content of the message is small and the encoding encapsulation cost is significant. Although an RTCP RPSI message may be piggybacked to the next rate control feedback message to decrease overhead, this delays the RPSI message until the next rate control feedback is sent. Thus, traditional approaches increase control loop delay. Note, that this added value is true for other encoding related notification messages, like picture loss indication.

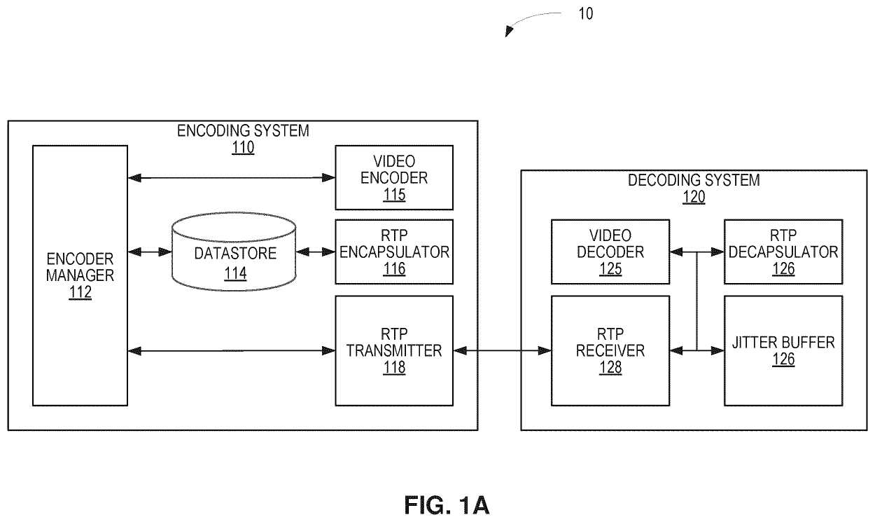

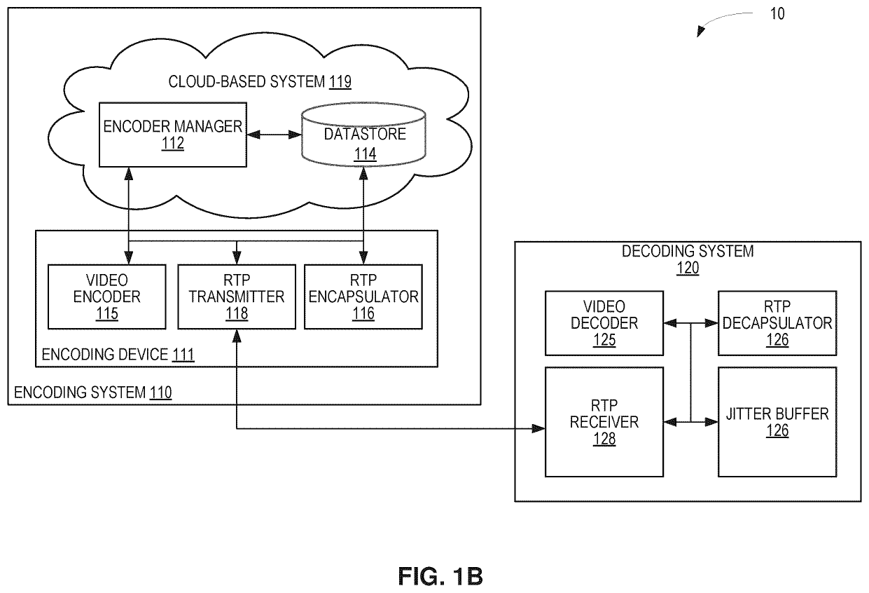

FIG. 1A illustrates an example network 10 comprising an encoding system 110 and a decoding system 120, each of which is its own computing system comprising any number of computing devices or components thereof, as will be described in further detail below. The encoding system 110 and decoding system 120 each comprise components that may be implemented by any combination of hardware and software, depending on the particular embodiment. Although FIG. 1A will describe the encoding system 110 and decoding system 120 in terms of particular components that perform particular functions for purposes of clear explanation. However, these components are merely one way to arrange the functions described herein. It should be appreciated that, in other embodiments, additional, fewer, or different components may be used. Generally speaking, the functions of any component may be attributed to the system 110, 120 in which it is comprised as shown in FIG. 1A or 1B in other embodiments.

The encoding system 110 and decoding system 120 are in communication with each other over a networking medium (e.g., cable, radio frequency). Although not shown for purposes of clarity, there may be any number of intermediate devices (e.g., routers, switches, gateways, proxies) between the encoding system 110 and decoding system 120 that carry messages between the systems.

For purposes of explaining various concepts of the encoding and decoding systems 110, 120, FIG. 1 illustrates a plurality of distinct components within each system. In this example, the encoding system 110 encodes an unencoded video stream into an encoded video stream (e.g., using video encoder 115), splits the encoded video stream into a series of RTP packets (e.g., using RTP encapsulator 116), and transmits the RTP packets over the transport network (e.g., via RTP transmitter 118), preferably such that overloading the network is avoided. The decoding system 120 receives the RTP packets (e.g., at RTP receiver controller 128), reconstructs the encoded video stream (e.g., at RTP decapsulator 126), and decodes it (e.g., at video decoder 125). To properly reconstruct the encoded video stream other components may be included, e.g., jitter buffer 126. The RTP transmitter 118 and RTP receiver 128 each implement rate control functions, as will be explained further below.

The encoding system 110 further comprises an encoder manager 112 and an RTP sequence map datastore 114 (sometimes referred to as an RTP-SEQ-MAP store). The datastore 114 stores an association between RTP packets and encoded video frames as well as the reception status of the RTP packets. The RTP encapsulator 116 writes entries into the datastore 114. More specifically, the datastore 114 comprises entries that establish a relationship between the encoded frame, the RTP packets carrying the content of the frame and the reception status of the frame as known by the transmitter 118.

In view of the above, an entry within the RTP sequence map may comprise a plurality of values. For example, an entry may comprise an encoder specific identifier of an encoded video frame. This value may be opaque to other components described herein. In some embodiments, an entry may additionally or alternatively comprise an encoder specific identifier of one or more parts of the encoded video frame (e.g. frame slice).

An entry may additionally or alternatively include one or more RTP packet descriptors. Each descriptor may, for example, comprise an RTP sequence number of the RTP packet, whether the RTP packet has been received at the decoding system 120, and/or whether the RTP packet has been declared lost. Additionally or alternatively, each RTP packet descriptor may comprise the transmission time of the RTP packet, the one-way network delay of the RTP packet, and/or an identifier of which parts of the encoded frame is carried in the RTP packet (e.g., a slice index).

An entry may additionally or alternatively include an indication of whether the entry is final (i.e., whether all the content of an encoded video frame has been passed to the RTP encapsulator 116). This flag may indicate that further RTP packets will not be registered to this entry. Accordingly, an indication that all RTP packets are available for decoding implies that the entire encoded frame is available for decoding.

The encoder manager 112 receives RTP transmission feedback information from the RTP transmitter 118, reads and modifies the datastore 114, and configures the video encoder 115 accordingly.

It should be noted that other embodiments may use other computing architectures than the one depicted in FIG. 1A. For example, the example of FIG. 1B depicts an encoding system 110 comprising an encoding device 111 and a cloud-based system 119. In FIG. 1B, the encoding device 111 comprises the video encoder 115, RTP transmitter 118, and RTP encapsulator 116, any or each of which may use the encoder manager 112 and/or datastore 114 provided by the cloud-based system 119 as a cloud-based service.

In another cloud-based example, it is possible to run the encoder manager 112 as a dedicated process on the same physical hardware device as the device that is streaming the video to the decoding system 120. Additionally or alternatively, the datastore 114 may be a shared medium between the encoder manager 112 and the components of the encoding device 111. Other centralized and/or distributed solutions may additionally or alternatively be employed without deviating from the inventive aspects of the present disclosure.

Irrespective of the particular arrangement of certain components of the encoding system 110, the RTP encapsulator 116 oversees construction of RTP packets from the content of an encoded video frame, and generates a series of RTP packets carrying the content of an encoded video frame. The video encoder 115 may pass the content of the whole encoded video frame in one invocation or in several invocations. The RTP encapsulation procedure may comprise collecting identifiers provided by the video encoder 115, metadata, and RTP sequence numbers and store these pieces of information in the RTP sequence map datastore 114. The metadata may include, for example, a presentation timestamp.

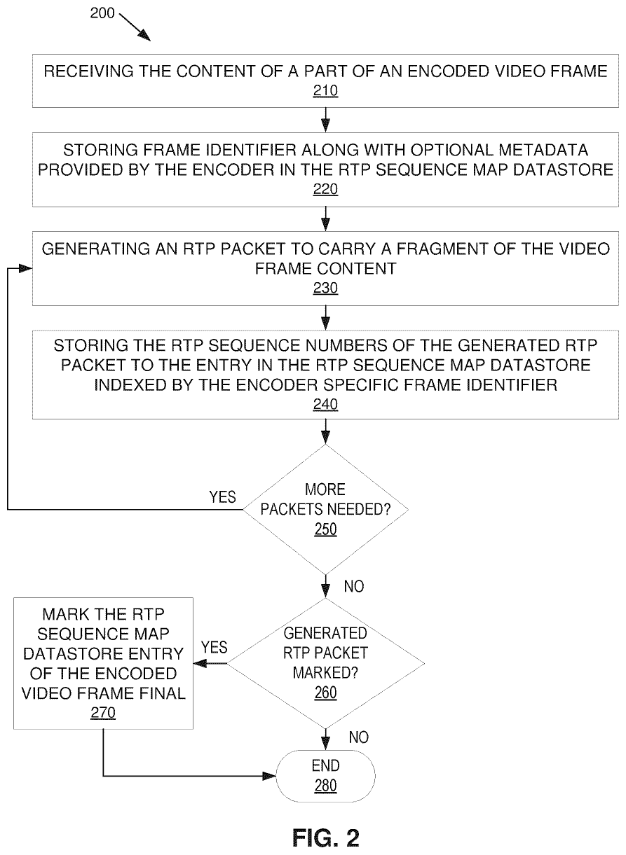

FIG. 2 is a flow chart illustrating an example RTP encapsulation method 200, according to one or more embodiments of the present disclosure. The method 200 is implemented by the encoding system 110 and, in some embodiments is more particularly implemented by the RTP encapsulator 116. The method 200 comprises receiving the content of a part of the encoded video frame (block 210). The content may, e.g., be received together with an encoder specific frame identifier and metadata provided by the video encoder 115. The content may be encoded as, for example, a series of Network Abstraction Layer (NAL) units.

The method 200 further comprises storing the encoder specific frame identifier and the metadata in the RTP sequence map datastore 114 (block 220). When there is no entry indexed with the said frame identifier, a new entry is created using the frame identifier.

The method 200 further comprises generating an RTP packet to carry a fragment of the video frame content (block 230). The fragment may, for example, be one or several small NAL units or part of a large NAL unit. As part of this step, a unique sequence number is generated for the RTP packet, which is included in the corresponding RTP field.

The method 200 further comprises storing the RTP sequence numbers of the generated RTP packet to the entry in the datastore 114 indexed by the encoder specific frame identifier (block 240).

The method 200 further comprises checking whether further RTP packets are needed to encapsulate the content of the encoded video frame part (block 250). If so (block 250, yes path), the procedure generates one or more further RTP packets as previously described (block 230).

If no further RTP packets are needed to encapsulate the content of the encoded video frame part (block 250, no path), the method 200 further comprises checking whether the last RTP packet generated is marked as the last one (block 260). For example, if the RTP packet comprises an RTP marker bit set to 0 (i.e., rather than 1) (block 260, no path), this may indicate that there are further parts of the same video frame, in which case the method 200 ends (block 280).

If, however, the whole frame has been encapsulated into RTP packets (block 260, yes path), the method 200 further comprises marking the entry of the encoded video frame in the RTP sequence map datastore 114 final (block 270), and the method 200 ends (block 280).

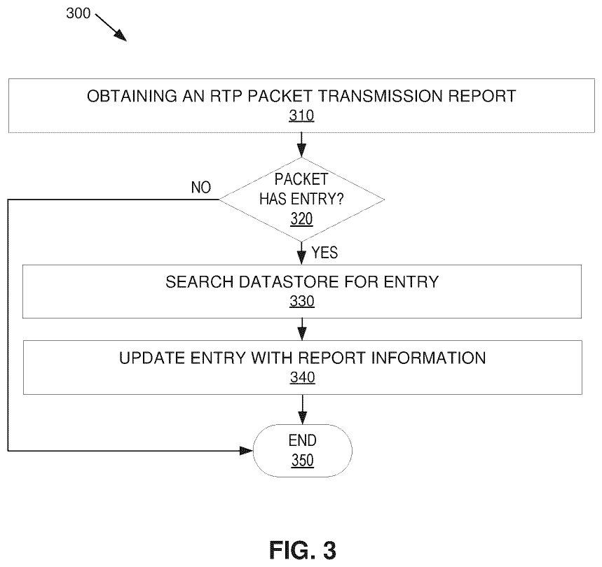

FIG. 3 illustrates another example method 300 implemented by the encoding system 110. In some embodiments, the method 300 is more particularly performed by the encoder manager 112. The method 300 comprises obtaining an RTP packet transmission report (e.g., from a rate controller such as the RTP receiver 128 and/or the RTP transmitter 118) (block 310). The report comprises a sequence number associated with an RTP packet and whether the RTP receiver side successfully received the packet (e.g., as opposed to having considered the packet lost).

In some embodiments, the one-way delay and/or other characteristics of the RTP packet are obtained as observed by the rate controller. Such information may be obtained from the rate controller periodically and/or in response to changes in the information. For example, the encoding system 110 and/or decoding system 120 may determine that a frame has arrived or has been lost and may, in response, generate the transmission information.

The content of the RTP packet transmission report may be reviewed to determine whether the packet has arrived on time or has been lost. For example, the report may include an explicit indication of whether the packet has been receiver or lost. Additionally or alternatively, the report may include the one-way network delay of a packet and use the delay as a basis for determining whether or not the packet has been lost.

The method 300 further comprises checking whether an entry in the datastore 114 exists for the packet referenced in the report (block 320). If there is no such entry (block 320, no path), the report is ignored and the method 300 ends (block 350). For example, a report that indicates a packet without an entry in the datastore 114 may indicate that the packet was not sent by the encoding system 110 or that some other error at the encoding system 110 or decoding system 120 has occurred.

If the packet corresponds to an entry in the datastore 114, the method 300 further comprises obtaining a descriptor of the packet from the appropriate entry (block 330). For example, to find the proper entry, the encoding system 110 may iterate through RTP packet descriptors of different entries until one is found whose sequence number equals the sequence number of the RTP packet.

The method 300 further comprises updating the entry in the datastore 114 that corresponds to the packet (block 340). For example, the encoding system 110 may update the RTP packet descriptor corresponding to the RTP packet with a corresponding indication of whether the packet has been received (and with the one-way determined network delay if calculated). In particular, the encoding system 110 may check whether the transmission report indicates that the RTP packet has been received or has been lost and update the datastore 114 accordingly. In one particular example, the encoding system 110 calculates the one-way network delay of the RTP packet using the local RTP packet transmission time and a reception time provided in the report to determine whether or not the packet was successfully received. Alternatively, a value provided in the report may be used to determine whether or not the packet was successfully received. In some embodiments, updating the entry may further comprise updating the entry with the one-way network delay (if available/determined).

In some embodiments, the encoder manager 112 may additionally consider information about the components involved in the packet exchange in determining whether or not a packet has been successfully received, e.g., so that the corresponding entry in the datastore 114 is appropriately updated. For example, the encoding manager 112 may be aware of the processing components at the receiver side residing between the RTP receiver 128 and the RTP decoder 125, the actual configuration of these components, and the one-way network delay of the RTP packet, any of which, individually or in any combination, may be considered at the encoding system 110. For example, a packet jitter buffer 126 may drop packets that do not arrive before a deadline determined based on, e.g., the RTP timestamp. The encoder manager 112 may estimate a reception deadline for the RTP packet and, if the reported reception time exceeds the estimated reception deadline, the encoding system 110 may consider the packet to be lost and may update the corresponding RTP packet descriptor in the datastore 114 accordingly. Having updated the appropriate entry, the method 300 ends (block 350).

The process of updating an entry in the datastore 114 may involve one or more checks or procedures. For example, when making an update to an entry, the entire entry may be reviewed to determine whether a determination can be made regarding the ability or inability of the decoding system 120 to successfully decode the corresponding frame (e.g., to deem a frame ready for decoding because all parts have been successfully received or unable to be decoded because the frame has missing or non-decodable parts).

Particular embodiments may follow one or more rules to make this determination. For example, the encoding system 110 may determine that an entire frame represented by an entry is decodable (e.g., ready for decoding) responsive to all RTP packets indicated by the entry as corresponding to the frame being marked available. In another example, the encoding system 110 may determine that an entire frame is non-decodable responsive to at least one RTP packet in the entry being marked lost. In yet another example, the encoding system 110 may determine that one or more slices is not decodable responsive to identifying that one or more corresponding packets is lost. In other words, if there is at least one RTP packet marked as lost, the frame slice(s) carried in the lost RTP packets may be deemed non-decodable.

The encoding system 110 may configure the video encoder 115 based on the outcome of the aforementioned frame review. In particular, the video encoder 115 can be configured to use a frame as a reference frame or to ignore the frame based respectfully on whether or not the frame was successfully received by the decoding system 120.

For example, the encoder manager 112 may configure the video encoder 115 to use frames that are determined to be ready for decoding (e.g., because they were successfully received) as reference frames.

In another example, the encoding system 110 configures the video encoder 115 with respect to particular slices of a frame of interest. For example, in response to the encoding system 110 determining that one or more slices of a frame is not decodable (e.g., because one or more packets corresponding to those slices was not received by the decoding system 120), the encoder manager 112 may configure the video encoder 115 to encode one or more subsequent frames or slices without reference to the non-decodable slices. In one particular example, the video encoder 115 may be configured to treat the non-decodable slices as intra-frame coded (i.e., coded without reference to other slices or frames).

In yet another example, the encoding system 110 may configure the video encoder 115 to encode a frame as an IDR frame responsive to an entire previously sent frame being considered non-decodable, e.g., in circumstances where a long term reference frame scheme is not used for error handling.

It should be further noted that, after using an entry from the datastore 114 to make a determination about whether a frame or slice is decodable and configuring the video encoder 115 accordingly as described above, in some embodiments, the encoding system 110 may then delete the entry datastore 114.

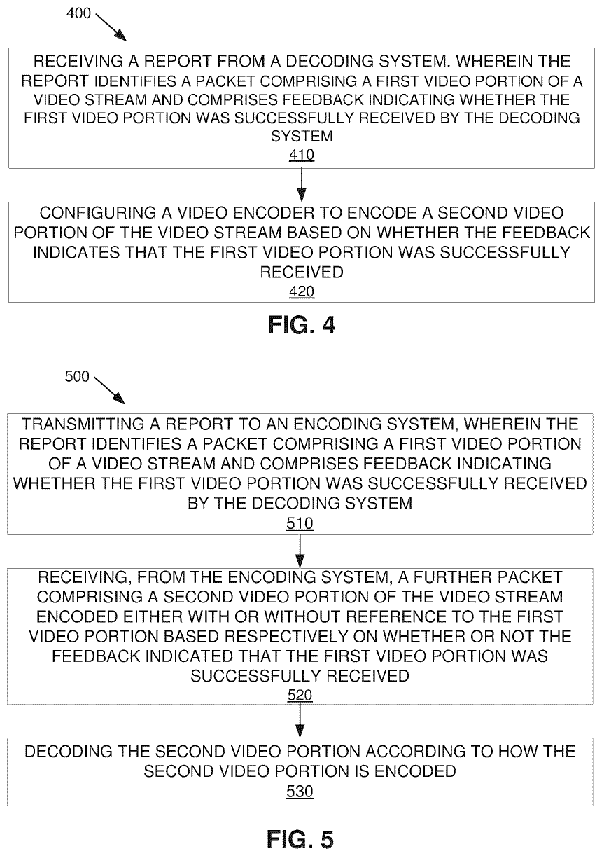

In view of the above, embodiments of the present disclosure include, for example, a method 400 implemented by an encoding system 110 as illustrated in FIG. 4. The method 400 comprises receiving a report from a decoding system 120 (block 410). The report identifies a packet comprising a first video portion of a video stream. Further, the report comprises feedback indicating whether the first video portion was successfully received by the decoding system 120. The method 400 further comprises configuring a video encoder to encode a second video portion of the video stream based on whether the feedback indicates that the first video portion was successfully received (block 420).

Other embodiments include, for example, a method 500 implemented by a decoding system 120 as illustrated in FIG. 5. The method 500 comprises transmitting a report to an encoding system 110 (block 510). The report identifies a packet comprising a first video portion of a video stream. Further, the report comprises feedback indicating whether the first video portion was successfully received by the decoding system 120. The method 500 further comprises receiving, from the encoding system, a further packet comprising a second video portion of the video stream encoded either with or without reference to the first video portion based respectively on whether or not the feedback indicated that the first video portion was successfully received (block 520). The method 500 further comprises decoding the second video portion according to how the second video portion is encoded (block 530).

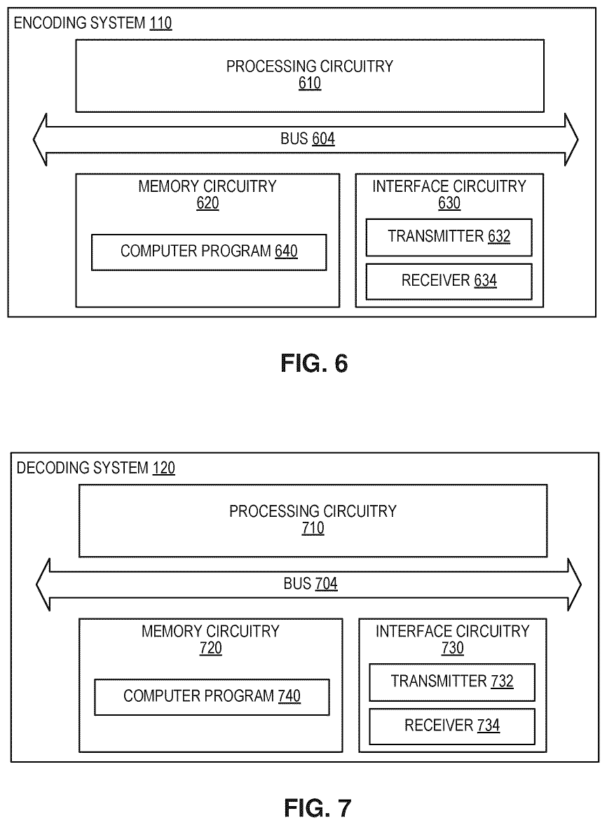

The encoding system 110 may, for example, be implemented as schematically illustrated in the example of FIG. 6. The encoding system 110 of FIG. 6 comprises processing circuitry 610, memory circuitry 620, and interface circuitry 630. The processing circuitry 610 is communicatively coupled to the memory circuitry 620 and the interface circuitry 630, e.g., via a bus 604. The processing circuitry 610 may comprise one or more microprocessors, microcontrollers, hardware circuits, discrete logic circuits, hardware registers, digital signal processors (DSPs), field-programmable gate arrays (FPGAs), application-specific integrated circuits (ASICs), or a combination thereof. For example, the processing circuitry 610 may be programmable hardware capable of executing software instructions stored, e.g., as a machine-readable computer program 640 in the memory circuitry 620. The memory circuitry 620 of the various embodiments may comprise any non-transitory machine-readable media known in the art or that may be developed, whether volatile or non-volatile, including but not limited to solid state media (e.g., SRAM, DRAM, DDRAM, ROM, PROM, EPROM, flash memory, solid state drive, etc.), removable storage devices (e.g., Secure Digital (SD) card, miniSD card, microSD card, memory stick, thumb-drive, USB flash drive, ROM cartridge, Universal Media Disc), fixed drive (e.g., magnetic hard disk drive), or the like, wholly or in any combination.

The interface circuitry 630 may be a controller hub configured to control the input and output (I/O) data paths of the encoding system 110. Such I/O data paths may include data paths for exchanging signals over a network. The interface circuitry 630 may be implemented as a unitary physical component, or as a plurality of physical components that are contiguously or separately arranged, any of which may be communicatively coupled to any other or may communicate with any other via the processing circuitry 610. For example, the interface circuitry 630 may comprise a transmitter 632 configured to send wireless communication signals and a receiver 634 configured to receive wireless communication signals.

The encoding system 110 may be configured to perform the method 400 described above. In one example, the processing circuitry 610 may be configured to receive a report from a decoding system 120 via the interface circuitry 630. The report identifies a packet comprising a first video portion of a video stream. Further, the report comprises feedback indicating whether the first video portion was successfully received by the decoding system 120. The processing circuitry 610 is further configured to configure a video encoder 115 to encode a second video portion of the video stream based on whether the feedback indicates that the first video portion was successfully received.

Still other embodiments include a control program 640 comprising instructions that, when executed on processing circuitry 610 of a encoding system 110, cause the encoding system 110 to carry out the method 400 described above.

Yet other embodiments include a carrier containing the control program 640. The carrier is one of an electronic signal, optical signal, radio signal, or computer readable storage medium.

Correspondingly, a decoding system 120 may be implemented as schematically illustrated in the example of FIG. 7. The decoding system 120 of FIG. 7 comprises processing circuitry 710, memory circuitry 720, and interface circuitry 730. The processing circuitry 710 is communicatively coupled to the memory circuitry 720 and the interface circuitry 730, e.g., via a bus 704. The processing circuitry 710 may comprise one or more microprocessors, microcontrollers, hardware circuits, discrete logic circuits, hardware registers, digital signal processors (DSPs), field-programmable gate arrays (FPGAs), application-specific integrated circuits (ASICs), or a combination thereof. For example, the processing circuitry 710 may be programmable hardware capable of executing software instructions stored, e.g., as a machine-readable computer program 740 in the memory circuitry 720. The memory circuitry 720 of the various embodiments may comprise any non-transitory machine-readable media known in the art or that may be developed, whether volatile or non-volatile, including but not limited to solid state media (e.g., SRAM, DRAM, DDRAM, ROM, PROM, EPROM, flash memory, solid state drive, etc.), removable storage devices (e.g., Secure Digital (SD) card, miniSD card, microSD card, memory stick, thumb-drive, USB flash drive, ROM cartridge, Universal Media Disc), fixed drive (e.g., magnetic hard disk drive), or the like, wholly or in any combination.

The interface circuitry 730 may be a controller hub configured to control the input and output (I/O) data paths of the decoding system 120. Such I/O data paths may include data paths for exchanging signals over a network. The interface circuitry 730 may be implemented as a unitary physical component, or as a plurality of physical components that are contiguously or separately arranged, any of which may be communicatively coupled to any other or may communicate with any other via the processing circuitry 710. For example, the interface circuitry 730 may comprise a transmitter 732 configured to send wireless communication signals and a receiver 734 configured to receive wireless communication signals.

The decoding system 120 may be configured to perform the method 500 described above. In one example, the processing circuitry 710 is configured to transmit a report to an encoding system 110 via the interface circuitry 730. The report identifies a packet comprising a first video portion of a video stream. Further, the report comprises feedback indicating whether the first video portion was successfully received by the decoding system 120. The processing circuitry 710 is further configured to receive, from the encoding system 110 via the interface circuitry 730, a further packet comprising a second video portion of the video stream encoded either with or without reference to the first video portion based respectively on whether or not the feedback indicated that the first video portion was successfully received. The processing circuitry 710 is further configured to decode the second video portion according to how the second video portion is encoded.

Still other embodiments include a control program 740 comprising instructions that, when executed on processing circuitry 710 of a decoding system 120, cause the decoding system 120 to carry out the method 500 described above.

Yet other embodiments include a carrier containing the control program 740. The carrier is one of an electronic signal, optical signal, radio signal, or computer readable storage medium.

Although the computing systems described herein (e.g., encoding system 110, decoding system 120) may include the illustrated hardware components, other embodiments may comprise computing systems with different components and/or combinations thereof. It is to be understood that these computing systems may comprise any suitable combination of hardware and/or software needed to perform the tasks, features, functions, and methods disclosed herein. Determining, calculating, obtaining or similar operations described herein may be performed by processing circuitry that processes information by, for example, converting the obtained information into other information, comparing the obtained information or converted information to information stored in a database, and/or performing one or more operations based on the obtained information or converted information, and as a result of said processing making a determination. Moreover, while components are depicted as single boxes located within a larger box, or nested within multiple boxes, in practice, the devices described herein may comprise multiple different physical components that make up a single illustrated component, and functionality may be partitioned between separate components.

1-15. (canceled)

16. A method, implemented by an encoding system, the method comprising:
receiving a report from a decoding system, wherein the report:
identifies a packet comprising a first video portion of a video stream; and
comprises feedback indicating whether the first video portion was successfully received by the decoding system; and
responsive to determining that the feedback indicates that the first video portion was successfully received, configuring a video encoder in the encoding system to encode a second video portion of the video stream using a video frame comprising the first video portion as a reference frame.

17. The method of claim 16, wherein configuring the video encoder based on the feedback comprises configuring the video encoder to encode the second video portion without reference to the first video portion in response to the feedback indicating that the first video portion was not successfully received.

18. The method of claim 17, wherein configuring the video encoder to encode the second video portion without reference to the first video portion comprises configuring the video encoder to designate a video slice comprising the first video portion as intra-frame encoded.

19. The method of claim 17, wherein configuring the video encoder to encode the second video portion without reference to the first video portion comprises configuring the video encoder to encode the second video portion as an Instantaneous Decoding Refresh (IDR) frame.

20. The method of claim 19, wherein configuring the video encoder to encode the second video portion as an IDR frame is responsive to the feedback and at least one further feedback received from the decoding system together indicating that an entirety of a video frame comprising the first video portion was not successfully received.

21. The method of claim 16, wherein configuring the video encoder to encode the second video portion using the video frame as the reference frame is in further response to the feedback and at least one further feedback received from the decoding system together indicating that an entirety of the video frame was successfully received at the decoding system.

22. The method of claim 16, wherein the feedback indicates that the first video portion was successfully received by indicating that a video slice comprising the first video portion was successfully received at the decoding system.

23. The method of claim 16, further comprising storing, in a datastore for each of a plurality of packets carrying respective portions of the video stream, an entry that associates:
a packet identifier that identifies the packet; and
a frame identifier that identifies a video frame comprising the respective portion;
with decoder feedback indicating whether the respective portion is decodable by the decoding system.

24. The method of claim 23, further comprising adding a further entry to the datastore for the packet based on the report.

25. The method of claim 16, further comprising:
determining a one-way network delay between a transmission time of the packet from the encoding system and a reception time of the packet at the decoding system;
interpreting the feedback as indicating that the first video portion is either decodable or not decodable based respectively on whether or not the one-way network delay is less than a threshold.

26. An encoding system comprising:
interface circuitry and processing circuitry communicatively connected to the interface circuitry, wherein the processing circuitry is configured to:
receive a report from a decoding system via the interface circuitry, wherein the report:
identifies a packet comprising a first video portion of a video stream; and
comprises feedback indicating whether the first video portion was successfully received by the decoding system; and
responsive to determining that the feedback indicates that the first video portion was successfully received, configure a video encoder in the encoding system to encode a second video portion of the video stream using a video frame comprising the first video portion as a reference frame.

27. The encoding system of claim 26, wherein to configure the video encoder based on the feedback, the processing circuitry is configured to configure the video encoder to encode the second video portion without reference to the first video portion in response to the feedback indicating that the first video portion was not successfully received.

28. The encoding system of claim 27, wherein to configure the video encoder to encode the second video portion without reference to the first video portion, the processing circuitry is configured to configure the video encoder to designate a video slice comprising the first video portion as intra-frame encoded.

29. The encoding system of claim 27, wherein to configure the video encoder to encode the second video portion without reference to the first video portion, the processing circuitry is configured to configure the video encoder to encode the second video portion as an Instantaneous Decoding Refresh (IDR) frame.

30. The encoding system of claim 29, wherein the processing circuitry is configured to configure the video encoder to encode the second video portion as an IDR frame responsive to the feedback and at least one further feedback received from the decoding system together indicating that an entirety of a video frame comprising the first video portion was not successfully received.

31. The encoding system of claim 26, wherein the processing circuitry is configured to configure the video encoder to encode the second video portion using the video frame as the reference frame in further response to the feedback and at least one further feedback received from the decoding system together indicating that an entirety of the video frame was successfully received at the decoding system.

32. The encoding system of claim 26, wherein the feedback indicates that the first video portion was successfully received by indicating that a video slice comprising the first video portion was successfully received at the decoding system.

33. The encoding system of claim 26, wherein the processing circuitry is further configured to store, in a datastore for each of a plurality of packets carrying respective portions of the video stream, an entry that associates:
a packet identifier that identifies the packet; and
a frame identifier that identifies a video frame comprising the respective portion;
with decoder feedback indicating whether the respective portion is decodable by the decoding system.

34. The encoding system of claim 26, wherein the processing circuitry is further configured to:
determine a one-way network delay between a transmission time of the packet from the encoding system and a reception time of the packet at the decoding system;
interpret the feedback as indicating that the first video portion is either decodable or not decodable based respectively on whether or not the one-way network delay is less than a threshold.

35. A non-transitory computer readable medium storing software instructions that, when run on processing circuitry of an encoding system, cause the encoding system to:
receive a report from a decoding system, wherein the report:
identifies a packet comprising a first video portion of a video stream; and
comprises feedback indicating whether the first video portion was successfully received by the decoding system; and
responsive to determining that the feedback indicates that the first video portion was successfully received, configure a video encoder in the encoding system to encode a second video portion of the video stream using a video frame comprising the first video portion as a reference frame.
